(19) United States
(12) Patent Application Publication
(10) Pub. No.: US 2020/0184465 A1
(43) Pub. Date: Jun. 11, 2020

(54) A SYSTEM FOR VIRTUAL CURRENCY BASED ON BLOCKCHAIN ARCHITECTURE AND PHYSICAL MARKING

(71) Applicant: Security Matters Ltd., D.N. Hevel Eilot (IL)

(72) Inventors: Tzemah Kislev, Mazkeret Bathya (IL); Nadav Yoran, Tel Aviv (IL); Haggai Alon, Kibbutz Naan (IL); Mor Kaplinsky, Herzliya (IL); Avital Trachtman, Tel Aviv (IL); Avraham Barhon, Kibbutz Degania A (IL); Ami Shafran, Ra'anana (IL); Guy Amir, Kibbutz Mishmar Haemeq (IL)

(21) Appl. No.: 16/609,686

(22) PCT Filed: May 8, 2018
(86) PCT No.: PCT/IL2018/050499

§ 371 Date: Oct. 30, 2019

Related U.S. Application Data
(60) Provisional application No. 62/503,067, filed on May 8, 2017.

(51) Int. Cl. G06Q 20/36; H04L 9/06; G06K 7/10

(52) U.S. Cl. CPC G06Q 20/3672; G06K 7/1099; H04L 9/0637

(57) ABSTRACT

Methods and system for management of transactions of marked objects are disclosed. In an embodiment, a method for recording a marked object includes: determining specific and unique marking of the object by a reader unit; and communicating encrypted data indicative of the marking and data indicative of the marked object to at least one server system, for generating at least one record of the object and its marking thereat. The at least one server system may be a distributed blockchain system including: at least one blockchain service module adapted for recording transactions of objects in a blockchain; and at least one management service module adapted for authorization of each transaction of an object based on authentication of the transaction by: providing a reader unit with a certain reading scheme/parameters that authorize/enable the reader unit to correctly read the specific marking on the object; and obtaining from the reader unit in response, a reading data indicative of the marking being read using the reading scheme, and authenticating the object based on a match between the reading data and stored data of the object's marking which is stored by the at least one server. In turn, before carrying out a request for recordation of a transaction for the object in the blockchain, the blockchain service module is adapted to await authorization of the transaction from the management service.

### TECHNOLOGICAL FIELD

The present invention is in the field of blockchain technologies and relates to system and method for management of object transactions via blockchain.

### BACKGROUND

Unique and high value objects are a typical example for items associated with commercial and financial values. Specific art pieces or jewelry are typically being transferred between owners together with documentations indicating object history and ownership, and may be exposed to forgery attempts.

Blockchain architecture based on a distributed ledger heralds the beginning of the internet 2.0 era, wherein not only information is transferred online (as in the ‘regular’ Internet) but value as well. Blockchain and blockchain-type distributed database are used for maintaining a record data, herein referred to as blocks, while providing resistance to data modification and copying of data. Generally, the blockchain utilizes continuously growing list of the data records, where new records are linked to older records providing updated data. Typically, blockchain-type data records provide a public registry utilizing a distributed computing system and configured to achieve data security from un-authorized changes. The architecture and design of the blockchain data base ensure that a digital data record cannot be duplicated and can therefore be used as a convertible virtual asset (such as bitcoin).

Techniques for using a blockchain platform to assist in verifying the authenticity of goods are known in the art. For example, US Patent Application No. 2016/0098723 discloses a method for block-chain verification of goods and authentication of inventory, which includes scanning, by a computing device, using a code scanner, an address from a code affixed to a product, verifying, by the computing device, that the address is associated with a crypto-currency transaction recorded at a transaction register, obtaining, by the computing device, at least one current transaction datum, and determining, based on the verification and the at least one current transaction datum, that the product is authentic.

### General Description

The present invention provides systems and methods for management (creating and updating) a database of coded physical items. The technique of the invention may be used for monitoring and transferring ownership of objects/items based on unique object marks or signatures in accordance with unique association between selected objects which are to be transacted and corresponding database records.

The present invention makes use of the blockchain architecture to provide a method for computer and virtual systems to interact with physical objects and assets. In particular, the present invention provides a method and a system for associating physical objects with virtual assets, (i.e. digital records), in a secure, one-to-one manner Namely, for creating and managing a correspondence between marked physical objects and digital records such that the correspondence cannot be corrupted. Specifically, the method and system of the present invention ensures that it will be extremely difficult to duplicate, delete or otherwise hack the digital record, and moreover wherein the physical object cannot be forged or duplicated and become in an unauthorized manner associated with a different digital record (i.e. the physical object cannot have two different identities in the virtual system). Furthermore, the physical object cannot become dissociated from its virtual record without leaving both a digital trace and a physical identifiable trace on the object itself.

For the purpose of preventing duplication and hacking of virtual records a blockchain database may be used ensuring that any change or update to a digital record must be approved by a majority of nodes (servers) within the blockchain system. For preventing counterfeit of or tampering with the physical object and for creating the correspondence between the physical object and the digital record the present invention utilizes a technique for marking the physical object and a novel scheme for creating and managing digital record involving the detection of the marking The marking and the scheme generating a physical signature on the object and a corresponding digital signature. The digital record associated with the physical object may comprise an open record stored on a blockchain database which can be viewed by the public, and may also comprise a closed part which is either stored in encrypted form on the blockchain database or stored only on a management database (which may be a privileged node or a server on the blockchain database). The closed part may be indicative of the digital signature and may include additional information about the marking of the object.

In an aspect of the present invention the management database may be managed by an authorizing/management centralized party and store information relating to physical and corresponding signature of the objects. The authorized body may authenticate the object and issue permits to record an object on the virtual system (including the management database and the management database). The blockchain database stores and manages the information regarding the ownership (and history of ownership) of the object, the object's origin, materials it is made of, current location and more.

In an example the information regarding the physical and digital signatures is open only to the authorizing/management party. That is, this information may not be available in the blockchain database and may not be available to the owner or the holder of the object. Additional information detailing the ownership (and history of ownerships) of an object may generally be managed by the blockchain database system. Such information may comprise a public key (in cases a public-private key encryption scheme is used) or other type of unique digital signature corresponding to the owner and a code identifying the object or alternatively include additional details regarding the owner and the objects, while may not hold other data associated with the object and/or its signature. In an example, the information may also comprise a value for the object. The value of the object may be updated once every preselected time period. Any change of ownership is typically registered in the blockchain database wherein the owner may prove her ownership employing a private key (corresponding to the public key published in the blockchain database).

The management party (e.g. service/server) may be involved in the process of changing ownership of an object for instance by confirming that an object is authentic (if such authentication is required), however it cannot perform any change to ownership and it does not have access to any data which can demonstrate or prove ownership (i.e. the signature or private key which is held by the owner).

The blockchain database of the present invention may also be associated with a virtual cryptographic currency (in the same way that the first blockchain is associated with the bitcoin). This virtual currency may be used to provide a value to the marked objects recorded on the database. The value of the object may be set by the owner when the object is first recorded in the system and may be updated by the owner at later time. Alternatively or additionally, the value of an object may be updated each time a transaction involving a change in ownership or partial ownership of the object is made, wherein the value is then set in accordance with the value of the object as set in the transaction. In an example the value of the object may be set and/or made available to the public only when a permission from the owner is provided.

Any private or commercial entity may become an owner of objects and optionally the internal virtual currency associated with the blockchain database. Through the use of Hierarchical Deterministic Keys such entity may own a plurality of objects by using a single private key which may be associated with additional depended private keys. The blockchain system of the present invention may be used as an exchange or a central market for barters wherein any object or partial ownership thereof may be bartered for any other object or part of an object. Moreover, as the present invention enables the division of ownership of any object to a plurality of owners any marked object or the record of such object may become a virtual currency in itself wherein transactions, prices, and values of assets are set relatively to the object.

The method of the present invention and the secure, one-to-one, association between the physical objects and the virtual record may provide a virtual platform for trading and implementing various operations, transactions and contracts involving physical objects. Such operations and transactions include the recording of an object in the blockchain database (creating a virtual asset) changing and updating ownership of an object, setting an updatable price to the object, and verifying the object's authenticity. Furthermore, due to the robustness of the method against attempts to forge and duplicate physical objects and digital records, the present invention may provide a platform for sharing ownerships of marked objects and goods and trading in partial ownership of an object (that is, trading in any percentage of the ownership of an object).

In general, the present invention provides at least two categories of transaction including conditional and non-conditional transactions, the non-conditional being transactions which may be carried out and finalized without being conditioned on any additional action performed by a party to the transaction or by the management database (e.g. a reading of marking of the object or transfer of currency). A non-conditional transaction may be carried out by the blockchain system without an involvement from the management database. Conditional transaction, are finalized only when a condition is met wherein the condition may be an action carried out by a party to the transaction (e.g. transfer of currency) or by the management database (e.g. verification that an object is appropriately marked).

Conditional Transactions relate to transactions associated with change in ownership of an object that may involve two or more parties and may be set to be conditioned on one or more conditions that may involve some or all the parties.

The transaction (change of ownership) may be conditioned upon the reading of the marking once the object is received by the party which will be the new holder of the object. This party may be the new owner or a third party (for instance a trusted party wherein the object is held in escrow). For example, the ownership of the object may be transferred to a plurality of owners while the object itself is to be held by one of these parties or by a trusted party which is not an owner of the object. In such transactions the blockchain database is configured to allow to complete the change of ownership only upon confirmation from the management database that a reading has been carried out and that the read mark was the correct on.

The transaction may be conditioned on an initial reading of the object prior to transferring ownership of transferring the object itself to a new holder (for instance, in order to verify that the owner or holder of the object does have the marked object).

The change of ownership may be conditioned on a set cost to be transferred to the owner of the object, wherein the cost may be set in a preselected currency which may be also a virtual currency. For example, the virtual currency may be an internal virtual currency associated with the blockchain database or in a different external virtual currency. In another example the cost may be set in terms of one or more marked and objects which may be used as a virtual currency. Namely, the change of ownership will be finalized only upon transferring ownership of the marked object or objects (or partial ownership thereof) used as virtual currency to the hands of the owner of the object. Such transactions may be conditioned on a plurality currency transfers from a plurality of parties (e.g. in a change of ownership from one or more owners to a plurality of new owners)

The change of ownership may be conditioned upon an action being carried out within a certain time frame (up to a certain date/time or from a certain time or both), wherein the action may be associated with any one of the above conditions (e.g. that a reading of a mark or the transfer of a cost are carried out up to a preselected time).

In order to facilitate transactions conditioned on one or more actions that be carried out by one or more parties, the blockchain system may employ Hierarchical Deterministic Keys, wherein for example a hierarchy of key pairs (private and public) is generated allowing, for example, a private key to control its sub-keys. For instance, in a transaction that is conditioned on a transfer of currency, the key by which the currency is transferred and the transaction is finalized may be higher in the hierarchy than the key by which the transaction was initiated. Such key pairs may have a preselected expiration date. Key pairs having a preselected expiration date may be used in conditional transections wherein one or more of the conditions has to be met within a preselected time. Conditional transactions may such that they may be revoked by the initiator of the transection (e.g. the owner of the object) at any time before the condition is met and the transaction finalized. Alternatively, a conditional transaction mat be such that it cannot be revoked once initiated prior to its expiration date (or other preselected time if such an expiration date was not preset).

As indicated above, objects (e.g. valuables) are associated with commercial and financial value, and are at times being transferred between owners. The conventional financial and authentication techniques require substantial effort in authenticating object documentation and ownership as well as tracing object's history. The present invention provides for a technique enabling high level monitoring of object history as well as securing ownership data utilizing computational analysis and suitable database structure. Additionally, the present technique enables the use of such suitable database for commercial and financial transferring of objects' ownership enabling unique and/or shared ownership and providing valid indication of the object data.

There is thus a need in the art for a technique and system enabling monitoring and updating data about valuable objects as well as enable commercial and financial use of object ownership, while providing high validity of the provided data and high security in data communication. The present invention utilizes a blockchain-type database in combination with unique marking provided on specific objects to provide such requirements. Generally, the present invention may utilize a blockchain-type database structure for maintaining ledger of marked objects. The terms blockchain and blockchain-type are thus used herein interchangeably referring to a distributed database operating on one or more servers and provides chain of linked history maintaining data records as described above.

The blockchain-type database according to the present invention may be used to securely store and provide data indicative of existence, ownership and additional parameters of specifically marked items. The different data pieces associated with the object may be publicly available or encrypted to be visible/readable using suitable cryptographic key associated with authorized readers (as described further below), object owner, and/or management key. Generally, the marked objects may be marked by various types of signatures including holograms, QR codes, UV or IR taggants, RFID tags, and X-ray signatures based of XRD or XRF. Further, in some embodiments, the object signature may be read using a specialized reader using predetermined reading parameters. To this end, the reader may be associated with a specific authorization for reading the marking and may be configured for securely obtain reading parameters associated with specific objects from the blockchain record associated with an object or from one or more servers associated with a management utility (management database). To this end, the database comprising blockchain-type records according to the present technique, may typically also be used for storing data about reading parameters to enable identification of corresponding objects securely, alternatively or additionally, such reading parameters data may be stored in one or more management related servers and accessible to authorized reader units in accordance with authorization key.

To this end, an entry data piece may be created upon providing certified scan/reading of a marked object (e.g. marked by holograms, QR codes, UV or IR taggants, RFID tags, and X-ray signatures based of XRD or XRF), such reading provides data indicating a unique object marking Additional data pieces associated with the object and included in the data entry include data indicating at least one of: Information regarding the manufacturing process, first/current ownership data, object description, certified marking/reading data. The object data may also include data about scanning/reading method providing specific instructions for detection of the object's mark and value data associated with the object. In this connection, it should be noted that suitable unique markings may be provided in accordance with a marking generation tool such that suitable markings may be authorized in accordance with data provided by one or more management servers. Accordingly, different markings may be associated with specific marking series and item identity as provided by said one or more management related servers.

The so-generated data entries are being processed and stored in a secured database according to the present invention. The database thus includes data indicating object-signature corresponding to a secure physical marking of the object; an owner (identified via a code) and may also include data about a manner in which the object-signature is to be read (i.e. detected or measured) from the object, e.g. type of authorized reader and/or reading parameters. In some configurations, the reading parameters may only be accessible by an authorized reader unit connectable to one or more management related server systems. In addition, the database record may include a financial value assigned to an object, whether static or updatable by various online means, which may be in any selected currency, linked to other objects' financial value in the blockchain, or in certain selected virtual/decentralized currency. Further, the database records may be stored in one or more storage utilities, providing decentralized database configuration for increased durability of data integrity. The database storage is configured to be an entry history maintaining configuration, (e.g. blockchain configuration) such that changes in data pieces provided after creation of each entry are stored in layered structure, or linked records, adding new and updated data while maintaining the previous data associated with updated fields of the corresponding data entry. Furthermore, updatable data corresponding with a certain object (e.g. current financial worth) may be stored in one or more storage utilities, maintained and managed by various third parties in centralized databases (such as, for example, NoSQL databases). It should be noted that a proven record of the history of ownership of an object may add to the value of the object, for example a famous previous owner would often increase the value of an object.

Generally, the technique of the present invention may utilize a distributed database including one or more servers associated with storage utilities providing at least one public record of the database. According to some embodiments, the database of the invention may be configured as a blockchain-type database providing secured and change resistant record. Accordingly, each data entry associated with a specific marked object may form a block or a record in a block, where updates of object data such as ownership or value data may be added as additional layer or linked blocks/records and be registered in a public record copy. As indicated above, at least some details of the object related record are typically public or semi-public (i.e. distributed in a decentralized ledger, with or without direct access from the internet), while some other data pieces may be encrypted and accessible with suitable decryption key, in most cases the user has the ability to control what data will be seen by each user.

Further, the technique of the invention utilizes physical marking of specific object to provide validation of the recorded data. More specifically, such marking may utilize any one of hologram, QR codes, UV or IR taggants, RFID tags, and X-ray signatures based of XRD or XRF, embedded in the object and configured to be permanently and physically associated with the object. The suitable object markings may be readable using standard or specifically configured reading system and may require specific scanning/reading protocol and parameters. Such unique object signature provides on one hand proper indication of the object's validity, and on the other hand may provide validation of a physical and unique object being associated to corresponding block/entry of the database. As described above, the secured database configuration and indication of reference to actual physical objects may provide both suitable register of valuables as well as corresponding marketplace where ownership rights may be traded.

Generally, a data record may be generated for a specifically marked object by providing suitable reading data of the object, or providing indication of marking data assigned to an object. More specifically, the technique may comprise assigning specific unique marking to one or more selected objects, and possibly marking the objects accordingly, providing the required reading parameters to a reader unit, reading a unique marking of the physical object and providing reading data (typically suitably encrypted) to a server associated with a management database; processing the data at the management database for determining that the reading data is authentic and generating object record and, typically, also assign the newly-created record to a public key of the object's first or current owner, who can identify and prove his ownership of the object and use all aforementioned possible applications using a corresponding private encryption keys; upon authenticating the object and reading data, the management server transmits suitable indication to at least one server (computation node) associated with the blockchain database for generating an object data record and displaying the record as part of the blockchain database. Generally upon reading an object, the reader unit may also be configured for transmitting data about the reading, e.g. including general description of the object, location and time of the reading without actual reading data, to the at least one server (computation node) associated with the blockchain, providing indication that an actual object was read and is associated with the requested record.

Once generated, an object data record provides a record data about the object, such as ownership data. Additionally, the corresponding data record is directly linked to the object in the meaning that the object code is associated with a unique marking of the physical object. Thus the data record provides indication that it is linked to an actual object, and identification of the object, e.g. by reading of the marking thereon, may provide direct relation to the corresponding data record.

Utilizing a blockchain-type database structure provides security and data integrity enabling monitoring object ownership and transferring rights associated with the object. Generally such object related transaction may be associated with actual reading of the object marking, thereby providing assurance of the transaction integrity.

To this end, updating of an object data record may be initiated by transmitting a request, through a computing system connectable to at least one server associated with the blockchain database. Typically, such update request may additionally be transmitted to one or more server system associated with the management database, requesting parameters associated with reading technique/calibration enabling identification of the object. The request may generally be transmitted to the Blockchain network (e.g. after being signed) using a private encryption key associated with the owner of the objects in question.

In response to a request for update object data, the server may provide data about reading parameters, which is typically stored securely in the management database or suitably encrypted in the object associated record. The reading parameters may be downloaded directly to an authorized reader unit, enabling it to scan/read and identify the unique marking of the object. The reading data (namely the marking data being read from the object) is generally transmitted to one or more servers associated with management database for processing the data update request and the reading data, e.g. processing raw reading data to identify unique marking Upon authenticating the reading data (i.e. confirming its matching to the expected marking expected to be on the object), at least one server associated with the management database is operated to transmit corresponding indication to at least one blockchain computing node/server for generating an updated object record.

In some cases, the corresponding indication may be transmitted to the blockchain node via the reader unit itself, to thereby provided that updating of a data record of the read object can be carried out without a direct connection between the management database and the blockchain system (nodes). In such embodiments the management database may transmit information to the reader unit that can be provided to the blockchain system which proves the marking was authenticated by the management database. The updated data record is generated linked to the existing record associated with the object and published in corresponding one or more servers associated with the blockchain-type database.

Accordingly, the present invention, in one broad aspect, provides a method for securely recording marked object comprising: providing one or more parameters for reading of unique object signature; using a reading system (e.g. hereinafter also referred to as reading unit) for determining specific and unique marking of the object to provided data indicative of said marking; using a computing device (optionally integrated with the reading unit) for communicating with at least one corresponding server system and transmitting data indicative of the marking, and data indicative of the marked object using an encryption key; and thereby enabling generation of at least one record of said transmitted data by the at least one server system.

In some embodiments, the at least one server system includes the at least one record stored on a public, semi-public and/or private database.

In some embodiments, the at least one server system includes a management service. The communication with the at least one corresponding server system includes providing data indicative of the object to said management service and receiving in response data indicative of reading parameters authorizing said reader unit to operate with a certain reading scheme for carrying out said determining of the specific marking of the object.

In some embodiments the reader unit is configured and operable to provide the data indicative of the marking to the management service/server, and the management service/server compares this data of the marking with recorder data of the marking stored thereby in order to determine authenticity of the object.

According to some embodiments the at least one server system includes a blockchain service and/or server adapted for recording transactions of the objects in a blockchain and a management service and/or server adapted for authorization of each transaction by determining authenticity of the transaction before its recordation by blockchain service. The management service/server determines the authenticity of the transaction by carrying out the following:
providing the reader unit with data indicative of reading parameters for authorizing the reader unit to operate with a certain reading scheme determining of the specific marking of the object;
obtaining in response, from the reader unit, data indicative of the marking being read utilizing said reading parameters;
comparing the received data (from the reader unit) indicative of the marking with stored data indicative of the marking on the object, and thereby authenticating the object based on a match between the stored- and received-data of the marking

In turn, upon request for recordation of a transaction for an object stored in the blockchain service/server, the blockchain service awaits/requests to receive the authorization of the transaction from the management service/server.

In this regards it should be noted that according to some embodiments of the present invention the management service/server is implemented by one or more secured severs as secured system. The blockchain service/server(s) may be implemented as at least one of public, semi-public, and/or private blockchain servers/databases. To this end, once the transaction is authenticated, it may be recorded and may be displayed as at least one record on a public or semi-public database of the blockchain service/servers/databases. Typically, the at least one corresponding server system may be configured as a management server system. Such management server system may store data indicative of the unique readout data and be configured for processing the data indicative of the marking, authenticate marking data with respect to reading parameters and data stored in the management database. Upon determining that the data is valid, the management system may transmit data indicative of the unique reading associated with the object in an irreversible encrypted form thus preventing, or at least significantly reducing exposure of the actual reading data.

Generally, providing one or more parameters for reading of unique object signature may comprise providing data indicative of suitable reading/scanning protocol for locating said specific unique marking of the object. For example, the marking technique may utilize X-Ray Fluorescence (XRF) system. In such embodiments, a corresponding XRF scanning/reading protocol may comprise data indicative of one or more of: filter type to be used during the XRF reading/scanning, calibration scheme and/or geometrical configuration for illuminating the read object and/or for receiving/detecting the XRF response therefrom, XRF reading voltage and/or current parameters (e.g. indicating a voltage/to be applied to an x-ray/gamma-ray emission tube used for illuminating the object being read during the reading/scanning and/or the current flowing through the emission tube), etc. Such data may be stored in a dedicated management server system (management database), and be transmitted to a dedicated/authorized reader unit in accordance with transmission of a corresponding reading request.

The transmitted data may also comprise data about value assigned to the object. The values may be in any type of currency, including decentralized currency and may be assigned to the object in accordance with input parameters provided with the object data or assigned be processing and analyzing the object parameters in accordance with existing data blocks available in public records.

Additionally, according to one other broad aspect, the preset invention provides a method for use in transaction of ownership rights of a marked object comprising: using a computing device communication with at least one corresponding server system and transmitting data indicative of a request for updating object record, said data comprises at least existing owner validation data, data about requested update, such as new owner validation data, and object marking data; processing at least one copy of public record associated with said object for validating said owner validation data and said object marking data and upon successful validation, generating at least one record of said transmitted data to be added corresponding record; and displaying the at least one updated record on a public database.

The method may further comprise, transmitting data about reading parameters of the corresponding object's marking to an authorized reader unit, and receiving the object marking data from said reader unit upon successful reading of the object's marking. Furthermore, cryptographic functions (e.g. homomorphic cryptography) combined with digital signature techniques may be used in order to verify object's authenticity, without access to the raw data recorded in the Blockchain or in the management server (i.e. without the private key required to decrypt the data in the Blockchain or the management server).

The transmitted update data may further comprise data indicative of value of transaction. In some embodiments, the method may further comprise affecting a transfer of corresponding currency in public record between existing owner public record and new owner public record. Example of such digital Blockchain-based trade platform using the unique marking of physical objects, uses virtual currency in order to settle transactions between two or more parties (e.g. every party has a private and public key and a form of wallet that keep records of the assets available and virtual currency available). Thus, the method may utilize the properties of decentralized currency for directly engaging transaction of value in response to registration of transfer of ownership of an object.

Generally, according to some embodiments of the present invention, the transmitted data may comprise data indicative of a portion of ownership being transferred. More specifically, an object record may register common ownership providing data about portion of the ownership associated to different parties, thus enabling transferring of portions of object ownership.

The product data entries generated in accordance with the above described methods may typically be stored in one or more server systems. Additionally, for increased security and transparency, copies of the data are typically stored in distributed peer-to-peer network providing certain level of public record. Thus, data stored in the database according to the present invention is generally accessible for maintaining integrity of the data.

To this end it should be noted that certain data pieces associated with object parameters might be stored as irreversibly encrypted copies thereof. For example, data indicative of the specific marking of the object may be stored in a way that the marking itself cannot be identified from the stored data. However, once the marking of the object is read/scanned, the identified marking is functionally associated with the stored corresponding data. Alternatively, or additionally, actual marking data may be stored, encrypted or in plaintext, in one or more servers associated with management database used for verifying reading data provided by an authorized reader unit. Accordingly, such one or more management related servers may be configured for processing reading data to identify object's marking data and provide corresponding indication to the one or more blockchain related servers for enabling object's record update.

According to yet another broad aspect of the present invention there is provided a distributed blockchain system including at least one server system comprising:
at least one blockchain service module adapted for recording transactions of said objects in a blockchain; and
at least one management service module adapted for authorization of each transaction of an object by determining authenticity of the transaction of the object before the recordation of the transaction by the at least one blockchain service module;

In such embodiments the object is being marked by a certain specific marking readable by a reader unit; the management service/server module is configured and operable for determining the authenticity of the transaction by carrying out the following:
authorizing said reader unit for reading said marking by communicating the reader unit with data indicative of reading parameters by which to read said marking by operating with a certain reading scheme for determining of the specific marking of the object;
obtaining from the reader unit, in response, data indicative of the marking being read utilizing said reading parameters; and
comparing said received data indicative of the marking with stored data indicative of the marking on the object and authenticating said object based on a match between the stored- and received-data of the marking;

To this end, upon request for recordation of a transaction for an object stored in the blockchain service/server, the blockchain service/server is configured and operable to await/request authorization of the transaction from the management service.

According to yet another broad aspect of the present invention there is provided a reader unit/system for reading unique marking physically coupled to an object to provided data indicative of the marking of the object. The reader unit is configured and operable for initiating communication with a predetermined management server before carrying out an operation of reading the marking, in order to receive from the management server authorization data for carrying out the reading, whereby the authorization data includes data indicative of reading parameters for operating the reading operation for reading the marking The reader is configured for, then, determining a signature of the unique marking of the object by carrying out the reading operation with the received reading parameters.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates a data block associated with a marked object according to some embodiments of the invention;

FIG. 2 illustrates a general communication topology according to some embodiments of the invention;

FIG. 3 illustrates a flow chart exemplifying method of generating object related data entry according to the embodiments of the invention; and

FIG. 4 illustrates a flow chart exemplifying method for use in transferring object rights and updating object data entry according to some embodiments of the invention.

### DETAILED DESCRIPTION OF EMBODIMENTS

As indicated above, the present invention provides a platform and technique enabling secured creation and updating of a dedicated database with respect to data associated with objects identifiable using secure physical marking In some preferred embodiments, the technique utilizes a blockchain-type database in the form of a distributed database such as a blockchain or blockchain-type database.

The present invention allows for a one-to one association of a marked object with a corresponding virtual/electronic record, such that the virtual record and/or the physical marking are configured to eliminate, or at least significantly reduce possibility of duplication, forging and/or changes by hacking, without proper authorization. The technique of the invention thus provides a secure platform supporting registration, maintenance, transactions and other changes in ownership or partial ownership of marked object while establishing suitable tracing between existing record and history of the object and enabling identification of the object in accordance with its corresponding record (and vice versa). The invention thus provides confidence in registered data, enabling users to be assured that for each virtual record there is one and only one marked object wherein the record cannot be hacked and the marking on the object cannot be removed without or tampered without leaving a trace which can be detected once the marking is read.

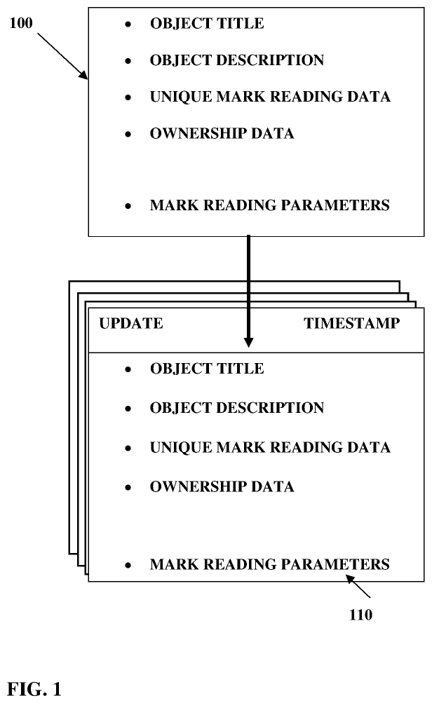

Reference is made to FIG. 1 schematically illustrating a data record (block-) chain associated with an object according to the present invention. As shown, an initial data entry 100 may be generated for the object upon providing suitable certificates and object parameters as will be described in more details further below. The database entry includes several data pieces associated with the relevant object. Such data pieces include object indication, e.g. title, corresponding object description, data indicative of unique object marking, data about object ownership, and may also include data about mark reading parameters.

The database structure is preferably configured to be history-preserving. More specifically, when data about the object is updated, e.g. in response to changes of one or more object parameters, e.g. ownership, the update data pieces are added to an additional/new data block 110, linked to the previous data. Further, the data blocks, as well as updated data pieces are generally stored in at least one public record, enabling tracing of object history and accordingly limiting, or preferably preventing, copying and/or false registering of object related data.

In this connection, the present technique relates to maintaining data relating to specific marked objects. Such objects may typically be valuable items, such as jewelry, precious stones, art pieces etc., which are embedded with specific and unique object-signature corresponding to a secure physical marking of the object. Data associated with an object may generally include ownership data (e.g. identified via a code such as personal public encryption key) and may also include additional parameters of the object.

Generally, reading of the unique marking signature of various objects may require use of specific reading parameters. Accordingly, the object data block of the present technique may also include data indicative of a way the object-signature is read (i.e. detected or measured). This data may include data indicative of authorized reader units and a corresponding address for actual reading parameters stored in one or more management related server systems, or encrypted or open copy of the reading parameters. The actual reading parameters may include specific reading technique, reading calibration data, or other parameters. This may provide correspondence of the object-signature to secure physical markings type, which may generally be holograms, QR codes, UV or IR taggants, RFID tags, and X-ray signatures based of XRD or XRF. As well as required analyzer parameters (e.g. for XRF analysis) that may include the set of parameters of the reading and possibly information corresponding to the calibration of the reader (that corresponds with the types of objects).

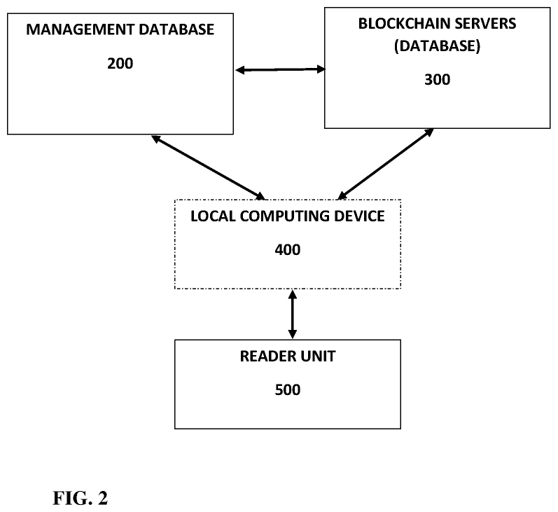

In this connection, the blockchain-type database may include public accessible data including. However, in some embodiments, the accessible data may be encrypted in way that is irreversible, i.e. processing actual reading data to establish that it corresponds to the publicly accessible data is simple, but identifying what would be the reading data based on the blockchain data may be impossible, or at least a very difficult processing task. To this end, a suitable copy of the object related data may be stored in a management database associated with one or more management related servers as exemplified in FIG. 2. More specifically, while the blockchain-type public record may include data about the object marking, the management database may be configured to encrypt the object marking data to the publicly accessible version thereof. Additionally, according to some embodiments, the management related server system may include/store parameters required for reading of the object and be configured for authenticating readout data in accordance with pre-stored marking data.

For example, the blockchain database stores, in its one or more corresponding servers, details of ownership and ownership history (e.g. including a public key identifying the owner), additional details relating to the object, the owner, reading history (e.g. when was the object examined by a reader system in the past and possibly reader system identification) and additional data. This is while the management database stores, in one or more corresponding management related server systems, reading data and reading parameters. The reading data relates to the actual object signature and reading parameters relate to suitable reading technique enabling an authorized reader system to provide correct and suitable reading data from the object. The selection between open and encrypted/hidden data pieces, which are available to the public on the blockchain data base may be set by the owner. Namely, the ownership record available to the public may by default may include only the public key of the owner while additional data may become available to the public or to defined users in accordance with permissions from the owner. As indicated above, object related data record 100 may generally include data pieces associated with Ownership data (typically provided as owner related code or public encryption key); unique marking signature data, e.g. data indicative of XRF reading based on natural or embedded signature. As indicated above, additional data may include reading/scanning parameters and/or object value.

The signature reading parameters may include parameter values for use by XRF reader (such as tube-current, tube-voltage, type of filters), as well as selected calibration parameters corresponding with object or XRF object-signature, to obtain and identify the correct XRF-signature. Accordingly, as indicated above, such reading parameters may be directly stored in the public data record, or stored in a corresponding management database record accessible by designated reader unit. In this connection, some specific XRF signatures may only be read, providing reliable data, using specific XRF reader types. Measuring so-marked objects with a different reader or with the designated reader but without using the exact parameters may provide false or incorrect XRF signature.

Generally, XRF, or any other object signature may be hidden, encrypted or covert such that the marking is invisible and configured to be hidden from unauthorized reading. In some other configurations, the marking may be visible, but encrypted, or fully visible, using added dye, ink etc. Such XRF signature may utilize small amounts of marker materials (i.e. materials which can be identified or measured by XRF analysis) providing the actual signature marking. For example, reading of the XRF signature may utilize signal processing, filtering and enhancing such as in the method described in PCT/IL2016/05340 incorporated herein by reference. The XRF signatures may be applied or added to the surface of an object as a continuous film or coating in localized areas. An XRF marking may be also incorporated within an object (i.e. in the bulk material of the object). An advantage of XRF marking is that it can be applied to or incorporated in an object without harming the object or affecting its physical, chemical, electrical and/or magnetic properties.

Object values may be determined in any type of currency being centrally controlled or decentralized (virtual) currency. The object value may be set in accordance with owner input, or periodically updated, for object types being in frequent trading. As indicated, the object related database according to the present technique may be a blockchain type database, and may be associated with one or more decentralized currency database architecture, enabling immediate trading when ownership data is being updated.

Reference is made to FIG. 2 exemplifying a general communication topology according to some embodiments of the invention. As shown, maintaining database for marked object may utilize communication network platform based on a distributed blockchain-type database 300 operating on a plurality of server systems, a management database 200 operated by at least one of the following: one or more secured server systems, a local computing unit 400 configured for mitigating data between a reader unit 500 and the management 200 and blockchain-type 300 databases/servers (in case the management database 200 is implemented in the block chain servers it is typically implemented as restricted/secured section of the blockchain which is not open to the public). The blockchain-type database 300 is typically based on public, linked, records. This is while the management database 200 is generally secured and not public.

In this regards, the blockchain servers implement a blockchain data structure per each object that is managed/recorder therein to thereby record the data indicative of the transaction history and/or owner data and/or other parameters of the object (e.g. data indicative of the signature, such as spectral response and/or other elementally coded symbols physically implemented by the marking that is embedded/included in/on the object). The management database/server (which as indicated above may be implemented as a part (e.g. secured and/or non-public part) of the blockchain servers and/or in independent servers, carries/stores data indicative of the markings (e.g. XRF mark and/or other marks) that is implemented/embedded in/on the object itself and even more specifically, it stores/recodes data indicative of the way such marking should be read. Such data may be associated with particular reader/reader-types which should be used to read the marking on the object, and/or with particular configuration of the reader (e.g. angle of illumination/detection and/or illumination radiation wavelengths and/or intensity) and reading parameters which should be used in order to obtain the correct marking signature from the marking on the object.

A reader for reading XRF marking (i.e. XRF analyzer) which may be used for the purposes of the present invention is described in International Patent Application Publication WO2018/051353, which is incorporated herein by reference.

To this end, whereby the blockchain servers implement a blockchain data structure recording the transaction history of the object, according to some embodiments of the present invention, each new transaction (e.g. each new block in the blockchain data structure of the object) should be authorized by reading the correct signature of the marking that is embedded/implemented in/on the object. However, as indicated above, the reading parameters by which correct reading of the marking is enabled are stored in the secured/non-public management servers. Therefore, in order to obtain/read the signature of the marking (which is required before committing a transaction to the blockchain) the reading parameters should be obtain from the management servers/service. To this end, during or before the reading operation, the reader unit 500 and/or the operator of the reader, should be authorized to access the management servers and obtain in secured (e.g. encrypted manner) the reading parameters. In this way, only authorized reading operations are enabled by the management server, thus eliminating the “risk” of recording false/counterfeit transaction (not authentic transaction) of the marked object in the blockchain servers. This is because according to the technique of the present invention, not only that the marking of the object should be read, the reading operation itself should be authorized (e.g. carried out by an authorized reader/operator), while unauthorized reading is restricted/not enabled in the absence of the correct reading parameters and/or reading authorization. Accordingly, the invention provides secured block chain transaction recording technique in which registering/recording each block/transaction of the block chain requires secured physical authentication of the marking of the object being the subject of the transaction.

It should be noted that in some embodiments a distinction is made between the actual signature data of the object's mark that is stored in the management servers and the optional marking data indicative of the object's mark that is stored in the blockchain record. The first, the signature data, may be data indicative of the actual signature of the object (possibly encrypted coded data). The second, being the marking data indicative of the object's mark which may be stored in the blockchain record, may be data that is only obtainable via a one way encoding of the actual signature data. In other words, once having the actual signature data and the encoding scheme, one may theoretically obtain the marking data which is stored in the blockchain server, however, not vice versa. The actual signature data cannot be obtained from the marking data. In such embodiments, only after the reading operation is completed, the management servers process the actual signature data that was read by the authorized reader/reading parameters, and restores therefrom the marking data that is stored in the block chain servers. Then, only in case the correct marking data is restored (by the management server), this data is provided for comparison with the marking data stored in the blockchain server to authorize the transaction (the new block in the block chain) in case the read marking data matches the stored marking data or otherwise not authorize the transaction (the new block). This adds another security layer making the marking data that is stored in the blockchain server (which may be public data) completely useless for use for counterfeiting transactions of the object (even by using fake management servers), since the marking data in the blockchain servers cannot be used to restore the actual signature data of the marking (due to the on way encoding).

In other embodiments the optional marking data that may be stored in the blockchain servers may be similar or indicative of the actual signature obtainable from the object marking, provided the suitable reading parameters.

In yet other embodiments the marking data may not be stored altogether in the blockchain servers, but instead each new transaction may require the authorization/authentication of the management servers/service, which in turn authorizes the actual reading of the marking on the object and verifies that the correct signature is obtained by the correct reading parameters and/or by the authorized reader unit, before authenticating and/or before providing authorization to the transaction.

Nevertheless, in all three above described embodiments of the present invention (whether the marking data is recorded in the blockchain servers, and/or matches the actual signature data or not), still secured transaction is obtained since reading authorization with the correct reading parameters and/or authorized reader requires the authorization of the management server. In turn no counterfeit transaction can be performed/registered in the blockchain servers without obtaining authorization/transaction-authenticity indication from the management servers. The later (transaction authenticity would only be obtain upon actually reading of the actual object by an authorized reader (and/or authorized reading operator) and/or with the correct reading parameters.

In this regards, generally, the reader unit 500 itself may be configured to eliminate, or at least significantly reduce security risks and data leaks from the system. More specifically, the reader 500 may be authorized, by the management database 200 to perform reading of specific objects or markings, and configured to not allow access to any data which may lead to exposing the markers (and their concentration) marking the object. The reader 500 and is configured to access the management database 200 via a corresponding computing device 400 to provide the management database 200 with data indicative of the alleged identity/type of the object which is to be read, and receive in response from the management database 200, data indicative of measurement/reading parameters (reading data) by which to read the object. In turn, the management database 200 stores records of each object being marked by the system whereby the record of each object (or of each object type) the reading parameters of the object and/or possibly data indicative of the signature of the marking obtained from the object in response to reading it with the respective reading parameters. As indicated above the reading parameters may include one or more of the following: the serial-numbers and/or types and/or any other reader identification data indicating the reader units which are authorized to read the object/object-type; the reading configuration parameters such as angles of illumination/detection; wavelengths and/or other parameters of the reading operation. In this regards it should be noted that at the first time an object is recorded in the system (e.g. in the management servers/service 200 which may and may not be integral part of the blockchains servers), the reading parameters of the marking on the object (as indicated above) are recorder in the management servers, as well as possibly the actual signature (e.g. spectral response; and/or coded symbols) of the marking of the object which is obtainable by those reading parameters. To this end, the present invention, in some of its embodiments, provide a technique for verifying that the physical measurement/reading of the correct object is performed before any transaction of the object can be committed/recorder to the block chain servers. This reduces, and practically eliminates the risk of recording any one of the following in the blockchain servers: counterfeited transactions of particular object; and duplicate registration of the same physical object in more than one blockchain structure. This also provides for verifying that any transaction committed to the blockchain is linked to the physical authentic object being the subject of the transaction, since the secured and authorized reading of the object is required.

Further, the reader computing device 400 may be configured to transmit data indicative of a reading to one or more servers of the blockchain database, such data may include indication of reading, location and time, typically without including reading data.

In the specific example of X-Ray fluorescence (XRF) object marking, the object may be marked with one or more additional materials providing unique XRF signature. Further, the actual object marking may be hidden between distracting reading data. Accordingly, a reader unit may be configured for receiving reading parameters indicating one or more of the following: XRF filters, current and/or voltage (energy) for X-ray emission source, calibration type (calibration data or type of calibration from a list stored in the reader), and/or reader type. Further, the reader 500 may provide raw reading data and transmit them using the local computing device 400 to at least one server of the management database for processing and authentication.

According to some embodiments, the reader 500 may be configured to maximize the amount of X-ray radiation that reaches the sample and is absorbed by the sample, and in particular the portion/fraction of that radiation that is absorbed by the element/marker that is to be measured, and to maximize the portion of the secondary radiation emitted from the measured element (the radiation emitted in response to the radiation incoming from the source) that reaches the detector.

The reader may be associated with a control system for controlling operational conditions of an XRF system for measuring on a sample. The control system is typically a computer system including data input and output utilities (software/hardware), memory utility, and data processor and analyzer module. The latter is preprogrammed for receiving input data including marker-related data about the marker(s) that is/are to be measured, processing the received input data to determine optimal geometrical characteristics of the XRF system defining optimal operational conditions of the system for measuring said marker(s), and generating corresponding output data for adjusting the geometrical characteristics of the XRF system.

The reader 500 may be configured as an X-ray Fluorescent (XRF) system for use in detection of at least one marker carried by a sample, the XRF system may include: an X-ray source for emitting primary radiation towards a sample plane; a detector for detecting secondary radiation from the sample; and a controller; wherein said controller is configured and operable for receiving operational data and adjusting geometrical characteristics of the XRF system may include at least one of the following: a distance between a primary radiation emitting plane of the X-ray source and a sample plane; a distance between a detection plane of the detector and a sample plane; angular orientation of an irradiation channel defined by the X-ray source; and angular orientation of a detection channel defined by the detector.

The reader 500 may be designed to obtain the data parameters for reading object marking from the management database 200, Once the measurement is done and the results sent to the database 200 the reader may generally be configured to go back into a standard state and delete the information retrieved and the outcome of the measurement (the spectrum and any information obtained from the spectrum) so that no information can be gained by opening the reader. For example, the mechanism setting the filter goes back to its initial standard state once the emitter stops radiating so the filter used in the measurement cannot be found. Further, the reader unit 500 may be configured to transmit a request for reading parameters, associated with a specific object (based on object id and owner id, to verify object identity). The request may be processed by one or more server systems associated with the management database 200, and reading parameters may be sent only to authorized reader units.

The reader 500 may also be configured to be locked in a closed housing, physically preventing a user from opening the housing of the reader and/or the housings of components inside the reader such as the emitter. For example, the physical security means may ensure that by applying physical force to the reader it breaks in such a way that the geometrical configuration of the emitter and the detector would not be revealed.

Data communication may typically be controlled by the local computing device 400 (may be associated with a control unit of the reader 500). The local computing device may generally be configured for encrypted communication with the management database 200 (or servers associated therewith). Such encryption may include the use of public key encryption, so that communication intercepted would not provide/reveal information about the reading parameters and/or reading results.

In an example, reader 500 may be assigned an ID, and may include means for verifying its location (e.g. a GPS). Every reading taken by the reader is recorded and documented in the management database and possibly at the blockchain database. That is, reader ID and reading location and time may be transmitted to the management database 200 and the blockchain database 300 indicating time and place of the reading and additional information such as the type of the object, the identity (or coded identity) of the owner of the object, the ID of the (authorized) person operating the reader, the purpose of the reading (for example, recording a new object, making a transaction or change of ownership, or checking whether the object is marked). The management database 200 may also record the outcome (the measured spectrum) of the reading, while providing an irreversibly encrypted version thereof to the blockchain database 300. The blockchain database 300 may thus record a coded version of the reading or a part of the reading data, for example be using one or more cryptographic means such as: cryptographic hash functions, public key encryption. For example, various strings of data associated with the marking and the reading of the mark on the object, such as the parameters of the reading and the signature of the object may be hashed separately and then combined or merged and hashed by a an additional hash function or otherwise encrypted by an additional encryption scheme. Additionally, partial or full homomorphic encryption schemes may be used to encrypt signature and reading data stored on the blockchain database allowing some mathematical operations to be carried out on the encrypted data.

Additionally, in some embodiments, the authorized reader units may include a hardware/software encryption component, configured for encrypting measurement results immediately upon reading. The encryption component may also be used for encryption of any other communication signals transmitted to or from the reader unit to thereby secure various software components against hacking, e.g. preventing from an unauthorized user to obtain source code data stored in storage utility associated with the reader unit 500.

Generally, hardware encryption components may be a removable component connected to the reader for example via USB wherein the reader may take a measurement only when connected to the encryption component thereby enabling operation by authorized users and preventing unauthorized reading.

As described above, according to some embodiments of the present invention, reading data, measured by authorized reader unit, may be encrypted and protected already at the electronic circuity of the reader unit 500. This may be embodied in a detector utility of the reader unit, configured for detecting electromagnetic radiation signals associated with one or more marker elements (e.g. heavy metal atoms) in/on the object. Generally, suitable electromagnetic signals detector utilities (e.g. Silicon Drift detector—SSD) are configured for transmitting one or more analog electrical pulses (originating from the detected electromagnetic signal) received and sorted to corresponding different channels by a Multi-Channel Analyzer (MCA). The MCA further sorts the analog signal to one of multitude of channels according to the signal's amplitude which corresponds to the signal's frequency (and energy). The measured spectrum may thus be constructed from the number of counts in each channel (i.e. number of count vs. frequency). The MCA may be configured for encrypting the detected spectrum data by addition and/or mixing of channels such that the frequency corresponding to a given channel (and thus the correct spectrum) cannot be obtained without suitable decryption, e.g. by reversing the mixing scheme.

As indicated above, the management database 200 may be operated by one or more secured server system (management server) configured to set and manage permission policy to one or more reader units 500. For example, only some reader units may have the permission to record a new object in the blockchain database while other reader units may be prevented from recording new objects, and may only be used for updating objects' data. Alternatively, some reader units may only be allowed to validate object data while not updating/changing it. The permission policy may also depend on additional factors such as: reading location, time, requirement of owner encryption key, owner identity, operator of the reader and other. For example, the management database 200 may allow to record a new object only during daytime; or require that for a specific owner or object the reading should be carried out by specific operators or readers. In another example recording of a new object of a certain type or belonging to a certain owner may be permitted in a certain location (e.g. store, distribution center). For example, in a case of a manufacturer who marks and records the manufactured products, recording the products may be permitted only in the manufacturing site. For example, a certain set of markings may be assigned to a specific line of manufactured objects (e.g. watches, jewelry, or any other items). The corresponding markings may be embedded in the objects upon, or after manufacture, by the manufacturer, or once distributed to private owners by selling. Accordingly, registering of objects in the database according to the present technique may be associated with validating the uniqueness of the marking such that once certain marking is assigned to an object, no additional objects can be registered using the same marking Generally, the technique of the invention may utilizes a plurality of separated management databases associated with different types of marked objects (e.g. by manufacturer). The different management servers (databases) may be configured to operate with the same or different set of reader units 500 while utilizing a common public blockchain-type database 300.

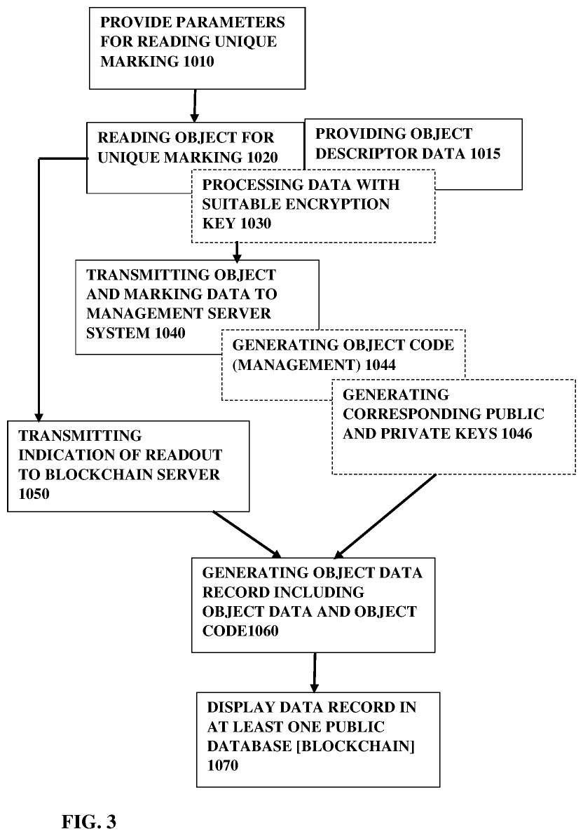

Reference is made to FIG. 3 illustrating a technique for registering marked object according to some embodiments of the present invention. As shown, for generating data block associated with an object, data associated with the object marking are provided to an authorized reader unit 1010, e.g. by providing manufacturer data. Additionally, certain data about the object are provided 1015, such as a text document including object description and value. To identify the actual/physical object, the object (its marking) is read/scanned 1020 by a suitable reader unit, which utilizes a local computing device for transmitting reading data 1030 (typically encrypted) to one or more servers of the management database. Typically, the local computing device may also transmit indication of reading to one or more servers of the blockchain database 1050 to provide indication of reading. To this end the object is scanned/read with a certifies reading system capable of identifying the object unique signature and providing data indicative of the signature to a computing system capable of communicating with one or more server systems associated with database storage. Typically, the additional data about the object is provided 1015 including ownership data and various other data parameters of the object.

The so-processed data is transmitted, typically using a computing system, to at least one server system 1040 associated with management database, for authenticating data integrity. The management server system may generate object code data 1044 (e.g. encrypted data of reading) and possibly corresponding public and private encryption keys 1046. The management server transmits the relevant data to one or more blockchain serves, which upon receiving authentication from the management server 1040 and indication of reading 1050 is configured for generating an object related block in the data base 1060. When the corresponding data block is stored and, if needed, further authentication is performed, the block data is displayed in at least one public database record 1070.

Generally, the at least one server system, and/or a computing system configured for transmitting object data (including signature related data) may be assigned with unique management authority. More specifically, an object block having no links to previously existing (in public database record) block may only be generate with one or more specific management encryption keys, at specific location(s) or using specific reading permissions as described above. Alternatively, the at least one server may be any server associated with the distributed database, and owner key and certified object signature readout is sufficient for generating a block with no previous links

Furthermore, in order to record a new object on the database the object should be marked. Such marking may be embedded in the object by a manufacture when assembling/constructing the object; the object may be marked by distributer, using suitable marking technique; or it may be marked by the owner. Generally, the unique marking of the object may be required to follow certain required properties enabling high verification data about the object. Typically, such markings provided by an authorizing/management party having access to marking system and suitable reader units. For example, when an object's owner wants to record an object in the database, the owner contacts the management party and provide the object for marking and inspection with a unique (e.g. XRF) signature.

In some examples, in order to record the object in the database the reader may connect to a cloud-based management database that manages and assigns signatures. Namely, the marking of the object may be done according to information stored on the management database and the reader (and possibly a marking device) communicates with the management database. Typically, the actual signature data may only be stored in the management database, and only data indicative, and irreversibly encrypted, thereof is provided in the object block database.

In this example, the reader communicates solely with a computing system associated with management-database. The computing system may then communicate with the at least one server storing data of the object block database to transmit data about the object for public registration.

According to some other examples, the object blocks database is internally managed according to a distributed management protocol and marking of selected objects may be provided by representative of the manufacturer or the seller of the object. For example, the owner of an expansive watch can carry-out marking in the store where the watch was purchased. Namely, the object may be marked in the store and the marking can be read by a designated reader in the store that then communicates with at least one server system associated with the database as described above.

As indicated above, the so-generated data blocks are publicly accessible, with required encryption for all or some of the data fields, and distributed to provide tracing of complete block update history. Thus, data records are known to be associated with existing objects having the unique marking and can be used, to some extent, as decentralized currency or tradable items. Specifically, ownership data of an object may be traded by generating suitable update to the database, where such update generally required at least usage of owner encryption key for preventing theft.

It should be noted, and as indicated above, a reader unit may generally transmit data indicative of a request for reading parameters from one or more servers associated with the management database. Such reading parameters' request may include data about the object to be read, reader unit identity and location. Generally such reading request may be processed in accordance with reading authorities scheme, e.g. certain object markings may only be read at designated locations, by authorized reader units. Accordingly, reading parameter may be transmitted to authorized reader units, or denied from unauthorized reader units in accordance with predetermined authorizing parameters.

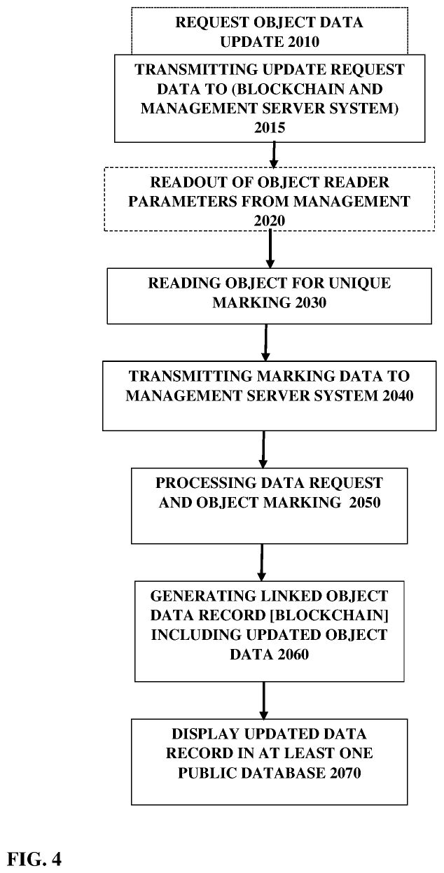

An exemplary process of updating object data is exemplified in FIG. 4. In this example, object update may require authentication of the object by proper reading/scanning As exemplified. A request for object update may be generated 2010, e.g. by object owner. The request may be transmitted to at least one blockchain server and at least one management server 2015. Accordingly, data indicative of object reading/scan parameters may be readout from the corresponding data field at the management database 2020 if such data field is stored with specific reading parameter. The parameters are to be provided to a suitable scanning system/reader unit, e.g. XRF reader, to enable scan/read of the object signature 2030. Upon reading object marking, the reader unit may utilize local computing device form transmitting marking data to at least one management server 2040 for processing. The management server receives the data update request and reading output data 2050 and authenticate the reading data 2050 with respect to existing record of the object marking If the reading data and owner key match the data in the management database, a corresponding indication is transmitted to one or more blockchain servers for generating 2060 object record with the updated data and linking it to the existing record of the object.

In an example, the indication that the reading data is authentic may be sent from the management server to the one or more blockchain servers via the reader or its local computing device such that the data updating process may not require direct communication between the management database and the blockchain system. In this case the management server may provide information to the reader which may be transmitted to the blockchain system proving that the reading data was inspected and authenticated by the management database.

The block may generally be updated using the current owner private encryption key to ensure certified update of parameters such as ownership. The desired update, e.g. complete or partial ownership transfer, may be registered an in updated record and linked to the object history record for integrity. As indicated, the transferred data is typically encrypted, and in this specific example it may be encrypted using current owner private encryption key.

Upon determining that the transmitted update request is valid and generating an updated data record 2060 linked to the previously existing record associated with the object. The so-generated data block is than transmitted to be distributed in the peer-to-peer database and displayed in the public record associated thereto 2070.

Thus, transfer of object ownership may be associated with a peer to peer agreement while note requiring any dedicated management. More specifically, when two parties agree to change ownership and transfer an object between them (including transfer of the actual object from one party to another), a reading of the object's signature may be requested to ensure validity of the transfer. Alternatively, in cased there is no request for signature reading, a use of owner private encryption key may be suitable for registering transfer of ownership.

It should be noted that an update request may or may not include actual update data for changing object data, e.g. ownership. An “empty” update request 2010 may be transmitted and used for reading/identifying object without any change in object data stored in one or more database servers. Accordingly, this may be done for verifying originality of an object, e.g. to demonstrate object, indicate against counterfeit suspicions etc. generally, any reading of an object marking, with or without data update may be recorded in a linked object related record and stored in the one or more servers of the blockchain-type database.

Such changing of ownership may, in some embodiments, be recorded first in a buffer and only upon receiving the object and reading the mark the change of ownership will be finalized and recorded in a block of the database. Alternatively, ownership changes may not require actual transferring the object itself, e.g., when the actual object is safely stored in a safe, transfer of partial ownership etc. The change in ownership may be recoded once the transaction agreed.

Generally, a signature reader unit suitable for providing signature data according to the present technique may be associated with one or more specific parameters ensuring validity of the read and uniqueness of the signatures. Typically, such reader unit may be configured for receiving readout parameters through an associated computing device, communicating with at least one server associated with the database. As indicated, the actual readout signature may typically not be transmitted as is, to prevent mark forging.

Once the measurement is done and the results sent to the database the reader may be configured to go back into a standard state and delete the information retrieved and the outcome of the measurement (the spectrum and any information obtained from the spectrum) so that no information can be gained by opening the reader. For example, the mechanism setting the filter goes back to its initial standard state once the emitter stops radiating so the filter used in the measurement cannot be found.

Thus, the present technique provides for a secure and distributed technique enabling validation, trading and maintenance of rights associated with uniquely marked objects. Such technique enables tracing of object history and identifying original/current owner of objects with or without presence of the object or the owner. Typically the technique utilizes decentralized database maintaining history data and having certain publicly accessible record, thus allowing error/theft corrections.

The use of the above described database may enable actual and virtual trading of marked objects utilizing an online virtual-currency type system (e.g. bitcoin-type payment system). Specifically, the invention enables trade with actual objects, possibly a trade which defines a virtual currency system. Furthermore, the invention allows one to trade with shares or partial ownership of marked objects. For example, to buy or sell a fraction of a work of art, or an expansive watch (just as one can buy or sell a fraction of a bitcoin, enabling one to invest, for instance, in Rolex watches without purchasing an actual watch).

1. A method for recording marked object comprising:
using a reader unit for determining specific and unique marking of the object to provided data indicative of said marking;
using a computing device for communicating with at least one corresponding server system and transmitting data indicative of the marking, and data indicative of the marked object using an encryption key;
thereby enabling generation of at least one record of said transmitted data by said at least one server system.

2. The method of claim 1 wherein said at least one server system includes said at least one record on a public, semi-public or private database.

3. The method of claim 1 or 2 wherein said at least one server system includes a management service; and wherein said communicating includes providing data indicative of the object to said management service and receiving in response data indicative of reading parameters authorizing said reader unit to operate with a certain reading scheme for carrying out said determining of the specific marking of the object.

4. The method of claim 3 wherein said reader unit provides said data indicative of said marking to said management service and said management service compares said data of the marking with recorder data of the marking stored thereby to determine authenticity of the object.

5. The method of any one of claims 1 to 4 wherein said at least one server system comprises a blockchain service adapted for recording transactions of said objects in a blockchain and a management service adapted for authorization of each transaction by determining authenticity of the transaction before its recordation by blockchain service; whereby:
said management service determines said authenticity of the transaction by carrying out the following:
providing said reader with data indicative of reading parameters for authorizing said reader unit to operate with a certain reading scheme determining of the specific marking of the object;
obtaining from the reader unit, in response, data indicative of the marking being read utilizing said reading parameters;
comparing said received data indicative of the marking with stored data indicative of the marking on the object and authenticating said object based on a match between the stored- and received-data of the marking;
and wherein said upon request for recordation of a transaction for an object stored in the blockchain service, said blockchain service awaits/requests said authorization of the transaction from the management service.

6. The method of claim 5 wherein said management service is implemented by one or more severs as secured system, and said blockchain service is implemented as at least one of public, semi-public, and/or private blockchain servers.

7. The method of any one of the preceding claims, further comprises transmitting, to one or more server system, a request for reading marking of one or more objects, receiving in response data indicative of one or more reading parameters enabling reading of the corresponding object's marking, and using the reader unit utilizing said one or more reading parameters for reading marking of the object.

8. The method of claim 7, wherein said one or more reading parameters comprise data indicative of suitable reading protocol for locating said specific unique marking of the object.

9. The method of any one of the preceding claims, wherein said communicating with at least one corresponding server system and transmitting data indicative of the marking comprises transmitting reading data to one or more management related servers in response to data about reading parameters, said one or more management related servers in response being configured for validating said marking data and transmit corresponding validation data for generating said at least one record of said transmitted data.

10. The method of any one of the preceding claims, wherein said reader unit system is an X-Ray Fluorescence (XRF) system; said one or more reading parameters comprise data indicative of suitable reading protocol for locating said specific unique marking of the object, said reading protocol comprises data about one or more of: filter type, emission tube current or voltage, calibration scheme and geometrical configuration for at least one of scanning and reading of said marking.

11. The method of any one of the preceding claims, further comprising assigning specific value to the object.

12. A method for use in transaction of ownership rights of a marked object comprising: using a computing device communication with at least one server system and transmitting data indicative of a request for updating object record, said data comprises at least existing owner validation data, and data to be updated; processing at least one copy of public record associated with said object for validating said owner validation data and said object marking data and upon successful validation, generating at least one record of said transmitted data to be added corresponding record; and displaying the at least one updated record on a public database.

13. The method of claim 12, further comprises, receiving, in response to said request for updating object record, data indicative of one or more reading parameters enabling reading of the corresponding object's marking; using a reader unit for reading a unique marking of the objects and transmitting corresponding marking data to said one or more server systems for validating said object marking data.

14. The method of claim 12 or 13, wherein said transmitted data further comprises data indicative of value of transaction; the method further comprises, effecting a transfer of corresponding currency in public record between existing owner public record and new owner public record.

15. The method of any one of claims 12 to 14, wherein said transmitted data comprises data indicative of a portion of ownership being transferred.

16. A method for generating a virtual currency from data indicative of physically marked objects thereby generate a virtual currency attached to a physical object, the method comprises:
using a reader unit for determining specific and unique marking of the object to provided data indicative of said marking;
using a computing device for communicating with at least one corresponding server system and transmitting data indicative of the marking, and data indicative of the marked object using an encryption key;
communicating said transmitted data and generating at least one record of said transmitted data; and displaying the at least one record on a public, semi-public or private database;
wherein the data indicative of the marking is hashed using cryptographic functions such that the data indicative of the marking will be kept hidden; and the virtual currency is generated using cryptographic functions from the cryptographically hashed data indicative of the marking and permanently stored in a database.

17. A blockchain system storing records of ownership of two or more virtual currencies, each of the two or more virtual currencies is associated with a physically marked object;
wherein ownership of a virtual currency or a part of a virtual currency can be changed and recorded in the blockchain system using a public key encryption scheme.

18. The blockchain system of claim 17 wherein the marking of physically marked objects can be detected by XRF analysis.

19. A distributed blockchain system comprising:
at least one server system comprising:
at least one blockchain service module adapted for recording transactions of said objects in a blockchain; and
at least one management service module adapted for authorization of each transaction of an object by determining authenticity of the transaction of the object before the recordation of the transaction by the at least one blockchain service module;
whereby:
said object is being marked by a certain specific marking readable by a reader unit;
said management service module is configured and operable for determining said authenticity of the transaction by carrying out the following:
authorizing said reader unit for reading said marking by communicating the reader unit with data indicative of reading parameters by which to read said marking by operating with a certain reading scheme for determining of the specific marking of the object;
obtaining from the reader unit, in response, data indicative of the marking being read utilizing said reading parameters;
comparing said received data indicative of the marking with stored data indicative of the marking on the object and authenticating said object based on a match between the stored- and received-data of the marking; and
wherein said upon request for recordation of a transaction for an object stored in the blockchain service, said blockchain service is configured and operable to await authorization of the transaction from the management service.

20. A reader unit for reading unique marking physically coupled to an object to provided data indicative of said marking of the object;
said reader unit is configured and operable for initiating communication with a predetermined management server before carrying out an operation of reading said marking for receiving from said management server authorization data indicative of reading parameters for operating the reading operation for reading said marking; and determining a signature of said unique by carrying out said reading operation with the received reading parameters.
